(19) United States
(12) Patent Application Publication
(10) Pub. No.: US 2003/0021429 A1
(43) Pub. Date: Jan. 30, 2003

(54) On-the-fly configurable audio processing machine

(76) Inventors: David D. Ratcliff, Plano, TX (US); Nicholas C. Kliewer, Plano, TX (US); Rustin W. Allred, Plano, TX (US)

Correspondence Address: TEXAS INSTRUMENTS INCORPORATED, P O BOX 655474, M/S 3999, DALLAS, TX, 75265

(21) Appl. No.: 09/918,377

(22) Filed: Jul. 30, 2001

(51) Int. Cl. H04B 1/00

(52) U.S. Cl. 381/119; 381/123

(57) ABSTRACT

A high performance audio processing device having significantly increased reconfigurability capabilities and that offers far more precision and throughput than its predecessors without increasing the per-channel cost of the device above the per-channel cost of the predecessors. The device architecture includes a single-cycle, 48×28 bit multiply feature that is configured as a sophisticated switch to minimize the use of branching such that the reconfiguration capabilities of the device are significantly increased. Multiplying by zero shuts a path off, while multiplying by one turns the path on, and multiplying by −1 turns the path on, but with an inversion of the path signal's phase. The use of a full-precision multiply rather than other forms of decision logic also allows “morphing” from one setting to another on-the-fly, and provides new operating states that are linear combinations of the “on” and “off” settings.

### BACKGROUND OF THE INVENTION

1. Field of the Invention

This invention relates generally to audio processing systems and methods, and more particularly to an audio processing machine that is configurable on-the-fly.

2. Description of the Prior Art

Known configurable, fixed-function, high performance audio processing devices are not programmable; but they are configurable enough to accomplish the requisite functions under a rather broad range of assumptions. Such devices, for example, can perform speaker equalization, a predetermined function, by applying downloaded filter coefficients, the configurable element. High performance and low cost of such devices has been achieved by limiting the flexibility. It is therefore important that correct assumptions are made about what functions are necessary, and that all the required hooks be in place to perform those functions. Too much configurability can overcomplicate the audio processing devices, making them more expensive, difficult to use, and more power hungry; while too little configurability can render such devices unusable in some target markets and unable to keep pace with market changes.

In view of the foregoing, a need exists in the marketplace for a high performance audio processing device having significantly increased configurability capabilities and that offers far more precision and throughput than its predecessors without increasing the per-channel cost of the device above the per-channel cost of the predecessors.

### SUMMARY OF THE INVENTION

The present invention is directed to a high performance audio processing device having significantly increased configurability capabilities and that offers far more precision and throughput than its predecessors without increasing the per-channel cost of the device above the per-channel cost of the predecessors. The device architecture includes a single-cycle, 48×28 bit multiply feature that is configured as a sophisticated switch to minimize the use of branching such that the configurability capabilities of the device are significantly increased. Multiplying by zero shuts a path off, while multiplying by one turns the path on, and multiplying by −1 turns the path on, but with an inversion of the path signal's phase. The use of a full-precision multiply rather than other forms of decision logic also allows “morphing” from one setting to another, and provides new operating states that are linear combinations of the “on” and “off” settings.

According to one aspect of the invention, an audio processing device achieves an unmatched degree of performance with far more configurability at greater size, power and per-channel cost savings than that available from general purpose, fully programmable devices such as digital signal processors (DSPs).

An audio processing machine architecture according to one embodiment comprises:

a plurality of audio inputs;

a plurality of audio outputs;

a plurality of audio filters;

a plurality of audio processing channels; and

a plurality of multiply switches configured to selectively mix the plurality of audio inputs and the plurality of audio outputs such that audio signals passing through the plurality of audio inputs are processed via a plurality of audio filters selected from the plurality of audio filters and a plurality of audio processing channels selected from the plurality of audio processing channels to generate at least one desired audio output signal.

Another embodiment of the present invention is an audio processing device comprising:

means for receiving a plurality of audio input signals;

means for generating a plurality of audio output signals;

means for filtering the plurality of audio input signals to generate a plurality of filtered audio signals;

means for processing the plurality of filtered audio signals to generate a plurality of processed audio signals; and

a plurality of multiply switches configured to selectively mix a plurality of audio input signals selected from the plurality of audio input signals, a plurality of filtered audio signals selected from the plurality of filtered audio signals and a plurality of processed audio signals selected from the plurality of processed audio signals to generate at least one desired audio output signal.

Yet another embodiment of the present invention is an audio processing device having a plurality of multiply switches operational to selectively mix a plurality of audio input signals, a plurality of filtered audio signals generated therefrom the plurality of audio input signals and a plurality of processed audio signals generated therefrom the plurality of filtered audio signals to generate at least one desired audio output signal.

A method of processing an audio signal according to still another embodiment of the present invention comprises the steps of:

a. configuring a first plurality of multiply switches, a second plurality of multiply switches and a third plurality of multiply switches;

b. mixing a plurality of audio input signals via the first plurality of multiply switches to generate a plurality of mixed audio signals;

c. filtering the plurality of mixed audio signals to generate a first plurality of filtered audio signals;

d. mixing the first plurality of filtered audio signals via the second plurality of multiply switches to generate to generate a second plurality of filtered audio signals;

e. processing the second plurality of filtered audio signals to generate a plurality of processed audio signals; and

f. mixing the plurality of processed audio signals via the third plurality of multiply switches to generate at least one desired audio output signal.

### BRIEF DESCRIPTION OF THE DRAWINGS

Other aspects, features and advantages of the present invention will be readily appreciated as the invention becomes better understood by reference to the following detailed description when considered in connection with the accompanying drawing figure wherein:

FIG. 1 is a simplified block diagram illustrating an audio processing device architecture according to one embodiment;

FIG. 2 is a simplified block diagram illustrating the audio processing device depicted in FIG. 1, but configured in a two-channel-in, three-channel-out arrangement where the third channel is derived by mixing the two input channels;

FIG. 3 is a simplified block diagram illustrating the audio processing device depicted in FIG. 1, but with the filters configured in a different sequence that, along with the mixing of left and right channels, effects what is known as a “stereo spreading” algorithm;

FIG. 4 is a simplified block diagram illustrating the audio processing device depicted in FIG. 1, but with the filters configured according to a head related transfer function (HRTF), accomplished in this architecture by changing coefficients, and wherein the mixing and filtering sequence is also configured only by coefficients;

FIG. 5 is a simplified block diagram illustrating the audio processing device depicted in FIG. 1, but with four channels filtered and downmixed to produce two outputs;

FIG. 6 is a simplified block diagram illustrating the audio processing device depicted in FIG. 1, but with the filters configured in yet another sequence via different switching paths;

FIG. 7 is a simplified block diagram illustrating the audio processing device depicted in FIG. 1, but showing a different slice of the overall architecture in greater detail that emphasizes the mixing capability and more particularly illustrates the internal functionality of the audio processing device; and

FIG. 8 is a simplified block diagram illustrating the slice depicted in FIG. 7, but configured to remove whatever is common between the left and right channels, to allow mixing in a third channel via different switching paths.

While the above-identified drawing figures set forth particular embodiments, other embodiments of the present invention are also contemplated, as noted in the discussion. In all cases, this disclosure presents illustrated embodiments of the present invention by way of representation and not limitation. Numerous other modifications and embodiments can be devised by those skilled in the art which fall within the scope and spirit of the principles of this invention.

### DETAILED DESCRIPTION OF THE PREFERRED EMBODIMENTS

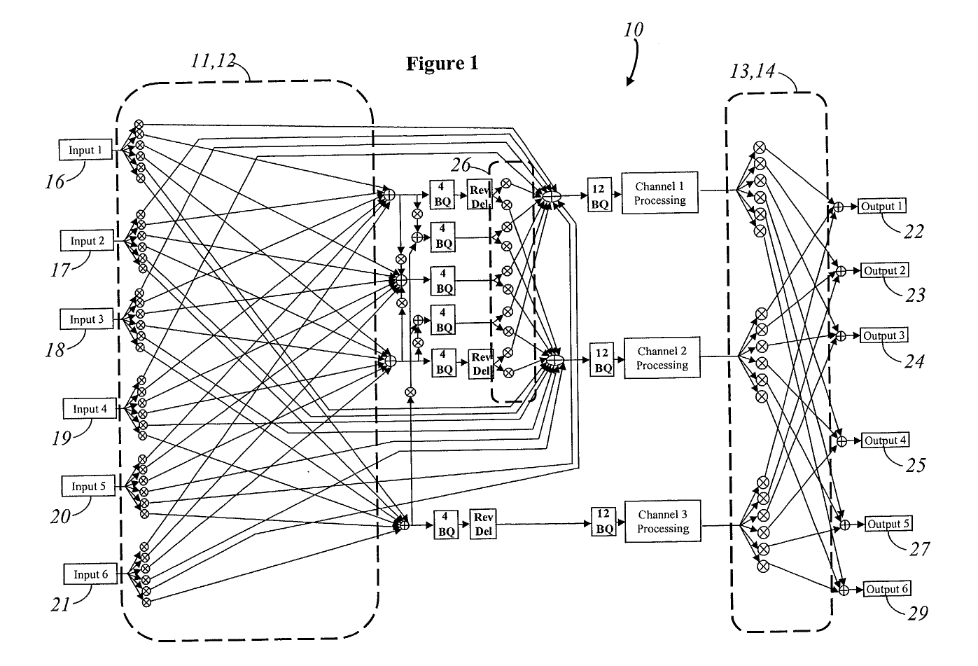

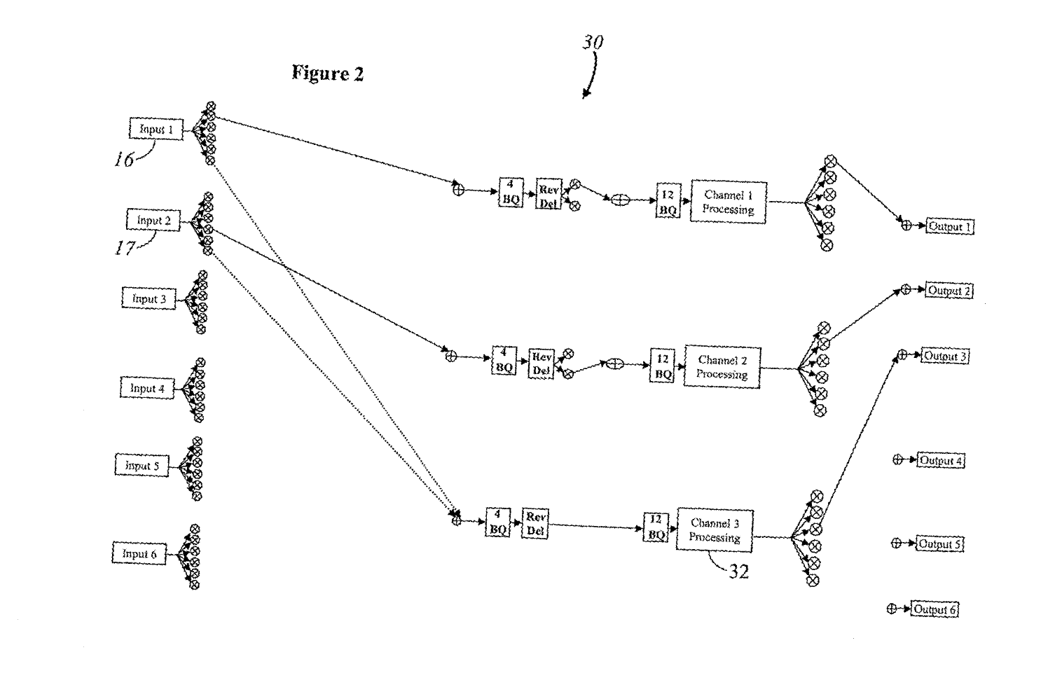

FIG. 1 is a simplified block diagram illustrating an audio processing device 10 architecture according to one embodiment. The audio processing device 10 has significantly increased reconfiguration capabilities and offers far more precision and throughput than existing general purpose, fully programmable devices such as DSPs that generally do not focus on a particular type of processing, without increasing the per-channel cost of the device above the per-channel cost of such general purpose devices. The audio processing device 10 architecture includes a single-cycle, 48×28 bit multiply feature that is configured as a sophisticated switch to minimize the use of branching such that the configuration capabilities of the audio processing device 10 are significantly increased. Multiplying by zero shuts a path off, while multiplying by one turns the path on, and multiplying by −1 turns the path on, but with an inversion of the path signal's phase. The present invention is not so limited however, and those skilled in the art will readily appreciate that the audio processing device 10 can also be configured such that different logic levels can be selected as desired or interchanged to implement the above described signal inversion and turning on/off the signal paths. The use of a full-precision multiply rather than other forms of decision logic also allows “morphing” from one setting to another on-the-fly, and provides new operating states that are linear combinations of the “on” and “off” settings. The present inventors found that while the present approach does have some inherent inefficiency, it turns out that this approach is generally more efficient than branching for the typically-encountered tasks. With continued reference to FIG. 1, the audio processing device 10 architecture depicts the full multiply/crossbar mix capability available on both the inputs 16-21 and the outputs 22-25, 27 and 29 of the device 10 via multiply switches 11 and their associated crossbar mix 12 as well as multiply switches 13 and their associated crossbar mix 14 respectively. This crossbar mix 12, 14 capability allows mixing and/or reordering of the inputs 16-21 and outputs 22-25, 27 and 29 in any desired manner. Those skilled in the art will therefore readily appreciate that a multitude of other multiply/crossbar mix configurations can be implemented as desired using the audio processing device 10 architecture. Further, multiply switches 26 in other areas of the audio processing device 10 allow the signal to be routed through various portions of the functionality in various ways. In summary explanation, the internal processor always executes the same code, but, by setting these switches 11, 13, 26 and other coefficients for filters and the like, the outcome changes significantly, as described herein below with reference to FIGS. 2-8.

FIG. 2 is a simplified block diagram illustrating the audio processing device 10 depicted in FIG. 1, but configured in a two-channel-in, three-channel-out arrangement 30 where the third channel 32 is derived by mixing two input channels 16, 17. It can be appreciated by those skilled in the audio processing art that this implementation is a straightforward application that is easily accomplished with the audio processing device 10 architecture.

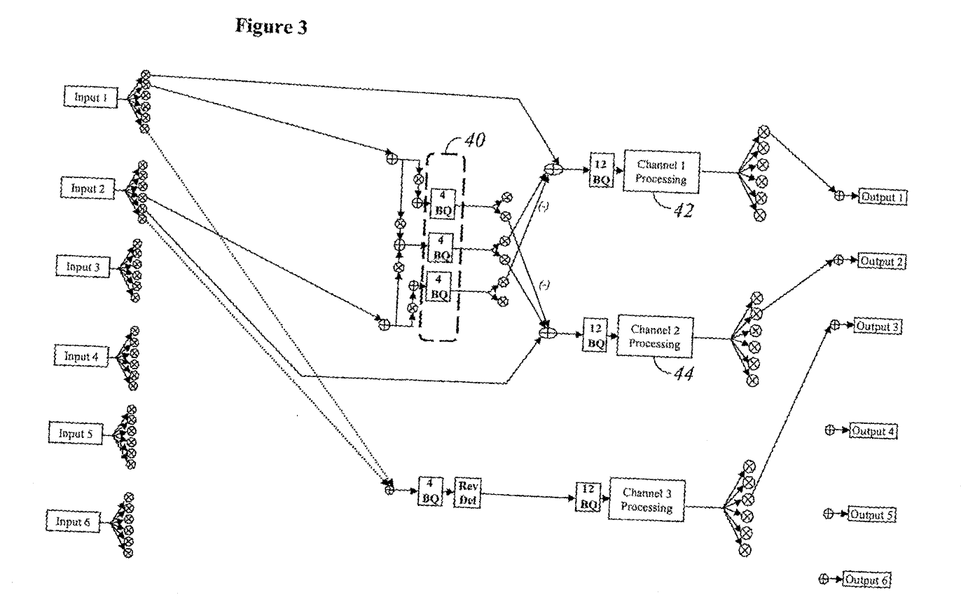

FIG. 3 is a simplified block diagram illustrating the audio processing device 10 depicted in FIG. 1, but with the filters 40 configured in a different sequence that, along with the mixing of left and right channels 42, 44, effects what is known as a “stereo spreading” algorithm. Although the application shown in FIG. 3 uses a slightly more complicated structure than that depicted in FIG. 2, it can still be derived simply by setting coefficients to modify the results of the same code, using the same overall architecture illustrated in FIG. 1. This is a typical application in platforms where the stereo speakers are quite close together, such as in television sets or laptop computers.

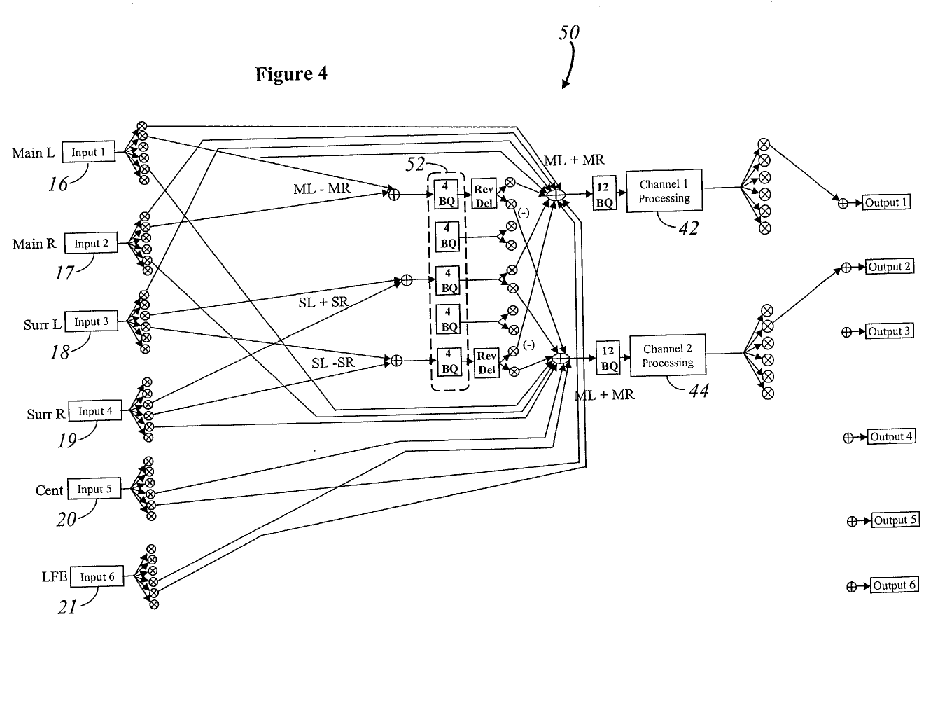

FIG. 4 is a simplified block diagram illustrating the audio processing device 10 depicted in FIG. 1, but with the filters 52 configured according to a head related transfer function (HRTF), accomplished in this architecture 50 by changing coefficients, and wherein the mixing and filtering sequence is also configured only by coefficients. The architecture 50 employed via audio processing device 10 assumes that a Dolby AC-3 signal has been decoded and that now it is desired to play those six channels 16-21 through a two-channel 42, 44 system. This is accomplished by “virtualizing” the surround speakers associated with inputs 18 and 19 wherein the filters 52 are configured as discussed herein above to give a listener the perception that the sound he/she would have heard from the six speakers of the surround system is present as he/she listens to only two speakers. Again, this is a typically-encountered configuration that must and can be easily and efficiently achievable by the architecture 50 implemented via the audio processing system 10.

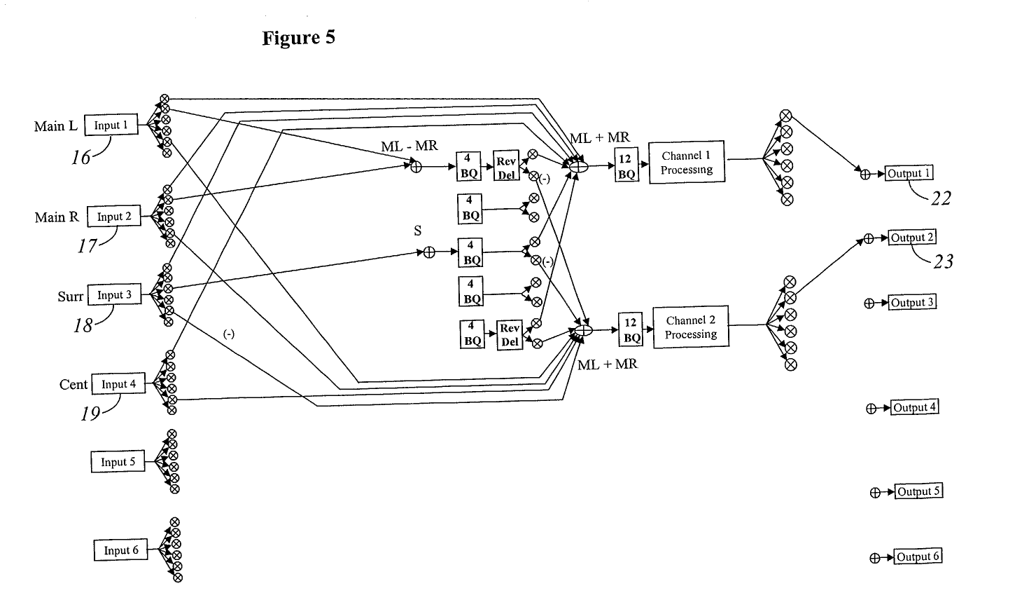

FIG. 5 is a simplified block diagram illustrating the audio processing device 10 depicted in FIG. 1, but with four channels 16-19 filtered and downmixed to produce two outputs 22, 23. This application is similar to that described herein before with reference to FIG. 4, but instead assumes a Dolby Pro input audio signal.

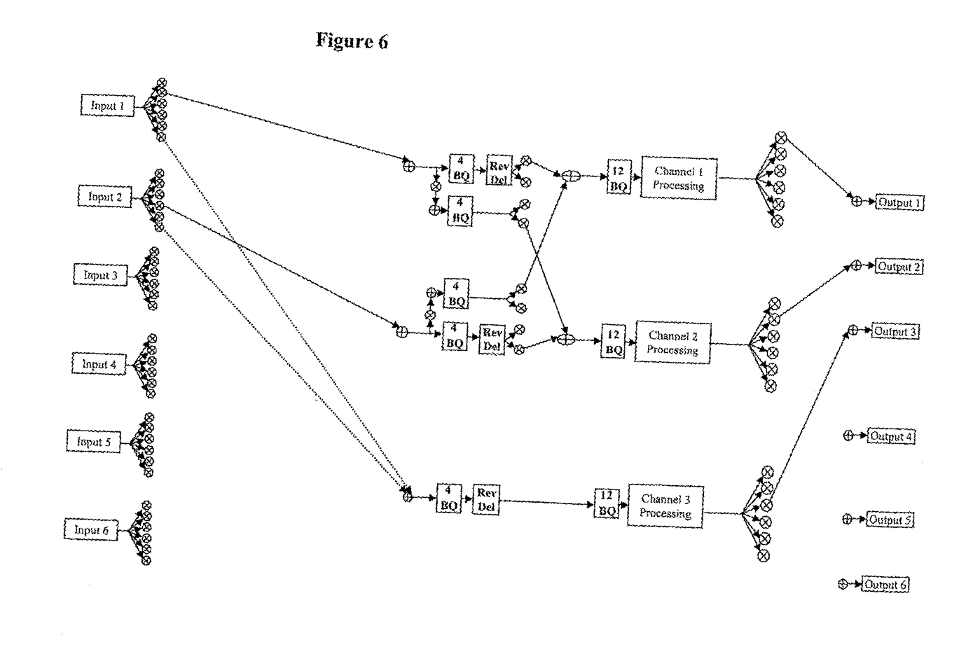

FIG. 6 is a simplified block diagram illustrating the audio processing device 10 depicted in FIG. 1, but with the filters configured in yet another sequence via different switching paths. It can be appreciated this application is similar to that described herein before with reference to FIG. 3; but instead, the filters are required to be sequenced in a different manner.

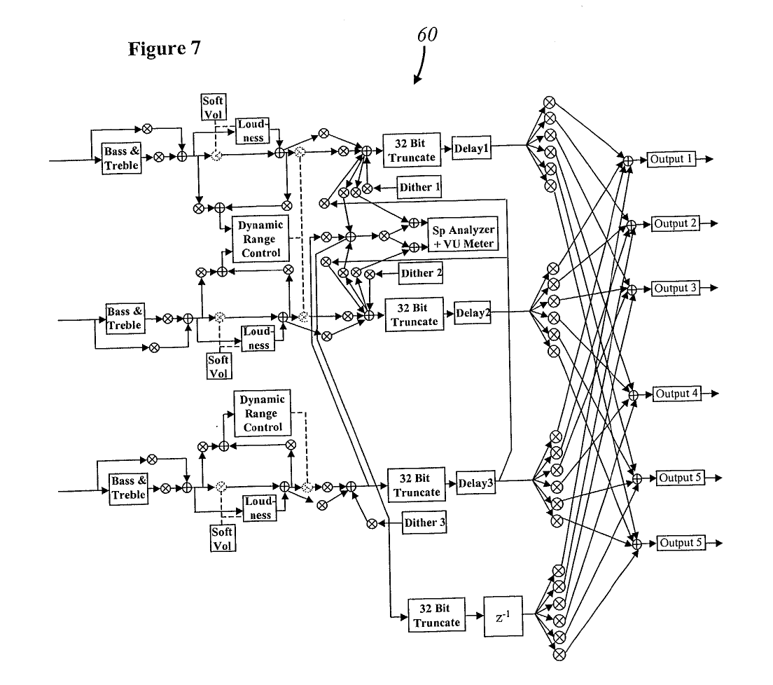

FIG. 7 is a simplified block diagram illustrating the audio processing device 10 depicted in FIG. 1, but showing a different slice 60 of the overall architecture in greater detail that emphasizes the mixing capability and more particularly illustrates the internal functionality of the audio processing device 10.

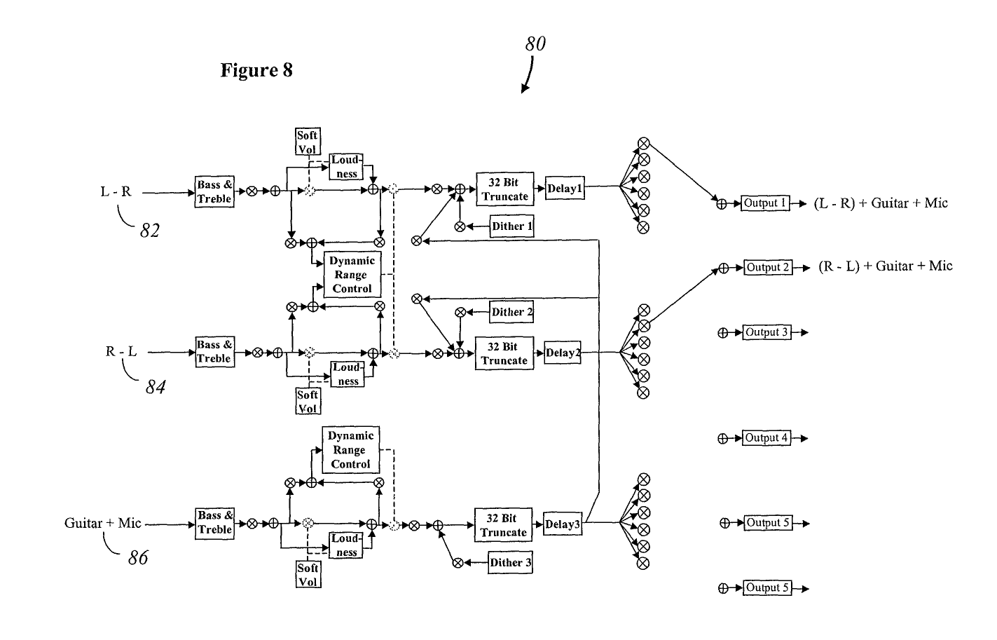

FIG. 8 is a simplified block diagram illustrating the slice 60 depicted in FIG. 7, but configured as a “karaoke mode” architecture 80 to remove whatever is common between the left and right channels 82, 84, to allow mixing in a third channel 86 where a karaoke singer is added in to replace the original vocalist via different switching paths.

In view of the above, it can be seen the present invention presents a significant advancement in the art of audio processing devices and techniques. The applications and architectures described herein before with reference to FIGS. 2-6 and 8 demonstrate only a small subset of what is possible with the overall architectures illustrated in FIGS. 1 and 7. It can be appreciated by those skilled in the audio processing art that this degree of flexibility will allow unique coefficient configurations that will enable new applications without the expense of manufacturing new silicon. Further, since this degree of configurability is available by only changing coefficients, and since changing coefficients is easily accomplished using, for example, an IIC bus integrated into the audio processing device 10, new configurations can actually take place on-the-fly in configurable end equipment. The emerging DVD-Audio standard, for example, allows for selections on the same DVD to have different sample rates and different numbers of channels. It can easily be appreciated that the audio processing device 10 architecture can easily handle a wide range of sample rates while also changing on-the-fly to handle different numbers of input channels and different processing required to meet the DVD-Audio standard. The flexibility afforded by the audio processing device 10 can also be demonstrated by considering another example in which a listener can listen to a CD, then flip a switch and move instantly into karaoke mode where he/she will suppress the lead vocalist and mix in his/her own voice in its place.

Those skilled in the audio processing art will readily recognize that much of the functionality described herein before is already available in other forms. The present architecture, however, avoids the overhead required for branching operations and multiple subroutines stored in a large memory, but is still efficient enough to perform a wide range of functions, has enough precision to perform at audiophile quality, even for 192 kHz sampling rates, and is flexible and configurable enough to change on-the-fly and to allow an extremely wide range of applications without changing the hardware.

This invention has been described in considerable detail in order to provide those skilled in the audio processing art with the information needed to apply the novel principles and to construct and use such specialized components as are required. In view of the foregoing descriptions, it should be apparent that the present invention represents a significant departure from the prior art in construction and operation. However, while particular embodiments of the present invention have been described herein in detail, it is to be understood that various alterations, modifications and substitutions can be made therein without departing in any way from the spirit and scope of the present invention, as defined in the claims which follow.

What is claimed is:

1. An audio processing machine comprising:
a plurality of audio inputs;
a plurality of audio outputs;
a plurality of audio filters;
a plurality of audio processing channels; and
a plurality of multiply switches configured to selectively mix the plurality of audio inputs and the plurality of audio outputs such that audio signals passing through the plurality of audio inputs are processed via a plurality of audio filters selected from the plurality of audio filters and a plurality of audio processing channels selected from the plurality of audio processing channels to generate at least one desired audio output signal.

2. The audio processing device according to claim 1 wherein the plurality of multiply switches are comprised of single-cycle multiply switches.

3. The audio processing device according to claim 1 wherein the plurality of multiply switches are comprised of programmable multiply switches.

4. The audio processing device according to claim 3 wherein the programmable multiply switches are reconfigurable on-the-fly.

5. The audio processing device according to claim 1 wherein the multiply switches are further configured to generate a first logic signal to open a conductive path, a second logic signal to close the conductive path, and a third logic signal to open the conductive path while inverting a signal phase associated with an audio signal passing there through.

6. The audio processing device according to claim 1 wherein the plurality of audio filters comprise biquad filters.

7. An audio processing device comprising:
means for receiving a plurality of audio input signals;
means for generating a plurality of audio output signals;
means for filtering the plurality of audio input signals to generate a plurality of filtered audio signals;
means for processing the plurality of filtered audio signals to generate a plurality of processed audio signals; and
a plurality of multiply switches configured to selectively mix a plurality of audio input signals selected from the plurality of audio input signals, a plurality of filtered audio signals selected from the plurality of filtered audio signals and a plurality of processed audio signals selected from the plurality of processed audio signals to generate at least one desired audio output signal.

8. The audio processing device according to claim 7 wherein the plurality of multiply switches are comprised of single-cycle multiply switches.

9. The audio processing device according to claim 7 wherein the plurality of multiply switches are comprised of programmable multiply switches.

10. The audio processing device according to claim 9 wherein the programmable multiply switches are reconfigurable on-the-fly.

11. The audio processing device according to claim 7 wherein the multiply switches are further configured to generate a first logic signal to open a conductive path, a second logic signal to close the conductive path, and a third logic signal to open the conductive path while inverting a signal phase associated with an audio signal passing there through.

12. The audio processing device according to claim 7 wherein the filtering means comprises a plurality of biquad filters.

13. An audio processing device having a plurality of multiply switches operational to selectively mix a plurality of audio input signals, a plurality of filtered audio signals generated therefrom the plurality of audio input signals and a plurality of processed audio signals generated therefrom the plurality of filtered audio signals to generate at least one desired audio output signal.

14. The audio processing device according to claim 13 wherein the plurality of multiply switches comprise single-cycle multiply switches.

15. The audio processing device according to claim 13 wherein the plurality of multiply switches comprise programmable multiply switches.

16. The audio processing device according to claim 15 wherein the programmable multiply switches are reconfigurable on-the-fly.

17. The audio processing device according to claim 13 wherein the multiply switches are configured to generate a first logic signal to open a conductive path, a second logic signal to close the conductive path, and a third logic signal to open the conductive path while inverting a signal phase associated with an audio signal passing there through.

18. A method of processing an audio signal, the method comprising the steps of:
a. configuring a first plurality of multiply switches, a second plurality of multiply switches and a third plurality of multiply switches;
b. mixing a plurality of audio input signals via the first plurality of multiply switches to generate a plurality of mixed audio signals;
c. filtering the plurality of mixed audio signals to generate a first plurality of filtered audio signals;
d. mixing the first plurality of filtered audio signals via the second plurality of multiply switches to generate to generate a second plurality of filtered audio signals;
e. processing the second plurality of filtered audio signals to generate a plurality of processed audio signals; and
f. mixing the plurality of processed audio signals via the third plurality of multiply switches to generate at least one desired audio output signal.

19. The method according to claim 18 further comprising the step of reconfiguring on-the-fly, at least one multiply switch selected from the first, second and third plurality of multiply switches and then repeating steps b-f.
